(19) United States
(12) Patent Application Publication
(10) Pub. No.: US 2026/0227781 A1
(43) Pub. Date: Aug. 6, 2026

(54) CLEANING DEVICE, CONTROL METHOD FOR CLEANING DEVICE AND RELATED DEVICE

(71) Applicant: Beijing Roborock Innovation Technology Co., Ltd., Beijing (CN)

(72) Inventors: Zhe LI, Beijing (CN); Shuangshuang WANG, Beijing (CN); Baoyu LI, Beijing (CN); Lina CAO, Beijing (CN)

(21) Appl. No.: 19/535,775

(22) Filed: Feb. 10, 2026

Related U.S. Application Data
(63) Continuation of application No. PCT/CN2024/117260, filed on Sep. 5, 2024.

(30) Foreign Application Priority Data
Aug. 29, 2023 (CN) 202311101601.7

(51) Int. Cl. G05D 1/246; A47L 11/40; G05D 105/10; G05D 109/10; G05D 111/10; G05D 111/50

(52) U.S. Cl. CPC G05D 1/246; A47L 11/4011; A47L 2201/04; G05D 2105/10; G05D 2109/10; G05D 2111/17; G05D 2111/52; G05D 2111/54

(57) ABSTRACT

A cleaning device, a control method for the cleaning device, a cleaning system and a non-transitory computer-readable storage medium are provided. The control method for the cleaning device includes: in response to a cleaning instruction, during operation of the cleaning device, acquiring map construction data for constructing an updated cleaning map; acquiring the updated cleaning map based on the map construction data; in a case where the updated cleaning map is abnormal, generating a map selection instruction; and receiving a user selection instruction and based on the user selection instruction, updating a map stored in the cleaning device.

### CROSS-REFERENCE TO RELATED APPLICATIONS

The present application is a Continuation Application of PCT Application No. PCT/ CN2024/117260, filed on September 05, 2024, which claims priority to Chinese Patent Application No. 202311101601.7, submitted on August 29, 2023, the entire contents of both of which are incorporated herein by reference.

### TECHNICAL FIELD

Embodiments of the present disclosure relate to the field of cleaning technologies, and in particular to, a cleaning device, a control method for the cleaning device, a cleaning system and a non-transitory computer-readable storage medium.

### BACKGROUND

As technology advances, cleaning robots have seen widespread adoption across industrial, commercial, and residential settings. However, in traditional technologies, in a case where a robot skids or is unexpectedly displaced, it will be at an incorrect position on a map. This prevents it from continuing its cleaning task, ultimately degrading the user experience.

### SUMMARY

According to a first aspect of embodiments of the present disclosure, a control method for a cleaning device is proposed. The control method for the cleaning device includes:

in response to a cleaning instruction, during operation of the cleaning device, acquiring map construction data for constructing an updated cleaning map;

acquiring the updated cleaning map based on the map construction data;

in a case where the updated cleaning map is abnormal, generating a map selection instruction; and

receiving a user selection instruction and based on the user selection instruction, updating a map stored in the cleaning device.

According to a second aspect of embodiments of the present disclosure, a control method for a cleaning device is proposed, which is applicable to a terminal and includes:

in response to a map selection instruction, sending a user selection instruction, wherein

the user selection instruction includes an original cleaning map selection instruction or an updated cleaning map selection instruction.

According to a third aspect of embodiments of the present disclosure, a cleaning device is provided. The cleaning device includes:

a memory, configured to store a computer program; and

a processor, configured to execute the computer program, wherein

the processor, when executing the computer program, implements the control method as described in any of the above technical solutions.

According to a fourth aspect of embodiments of the present disclosure, a cleaning system is proposed. The cleaning system includes:

the cleaning device as described in the above technical solution; and

a cleaning base station, configured to provide maintenance for the cleaning device.

According to a fifth aspect of embodiments of the present disclosure, a non-transitory computer-readable storage medium is provided.

The non-transitory computer-readable storage medium stores a computer program to implement the control method as described in any of the above technical solutions.

### BRIEF DESCRIPTION OF DRAWINGS

Various other advantages and benefits will become apparent to those of ordinary skill in the art upon reading the following detailed description of preferred embodiments. The accompanying drawings are only for the purpose of illustrating preferred embodiments and should not be considered as limitations on the present disclosure. In addition, throughout the accompanying drawings, the same reference signs denote the same components. In the accompanying drawings:

FIG. 1 is a schematic step flowchart of a control method for a cleaning device according to an embodiment of the present disclosure;

FIG. 2 is a schematic step flowchart of a control method for a cleaning device according to another embodiment of the present disclosure;

FIG. 3 is a schematic step flowchart of a control method for a cleaning device according to still another embodiment of the present disclosure;

FIG. 4 is a structural block diagram of a computer-readable storage medium according to an embodiment of the present disclosure; and

FIG. 5 is a structural block diagram of an electronic device according to an embodiment of the present disclosure.

### DETAILED DESCRIPTION

In order to better understand the above technical solutions, the technical solutions of embodiments of the present disclosure are described in detail below through the accompanying drawings and the specific embodiments, and it should be understood that the embodiments of the present disclosure and specific features in the embodiments are detailed descriptions of the technical solutions of the embodiments of the present disclosure, and are not the limitations on the technical solutions of the present disclosure. Without conflict, the embodiments of the present disclosure and the technical features in the embodiments may be combined with each other.

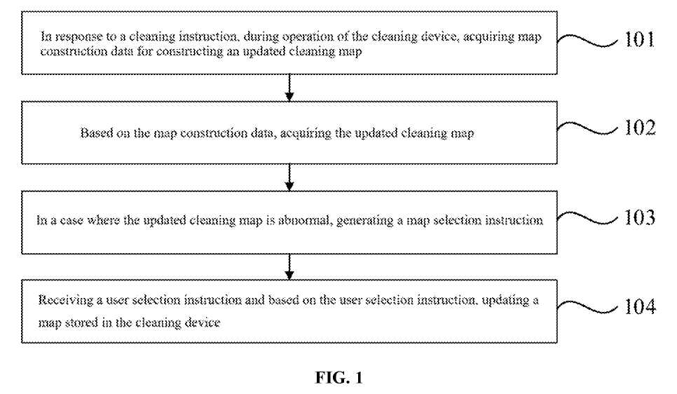

As shown in FIG. 1, according to a first aspect of the embodiments of the present disclosure, a control method for a cleaning device is proposed, which is applicable to the cleaning device and includes the following steps.

In step 101, in response to a cleaning instruction, during operation of the cleaning device, map construction data for constructing an updated cleaning map is acquired. It may be understood that the cleaning instruction may be sent by a user or generated by the cleaning device itself. For example, a time threshold may be set for the cleaning device. When the time elapsed since the previous operation of the cleaning device exceeds the time threshold, it may be considered that the cleaning device has been idle for a long time. In this case, the cleaning device may generate the cleaning instruction by itself. It may be understood that after receiving the cleaning instruction, the cleaning device may perform a cleaning operation in response to the cleaning instruction. In this process, the cleaning device may collect the map construction data for constructing the updated cleaning map.

In step 102, based on the map construction data, the updated cleaning map is acquired. It may be understood that the updated cleaning map acquired based on the map construction data is a new map compared with an original cleaning map.

In step 103, in a case where the updated cleaning map is abnormal, a map selection instruction is generated. It may be understood that the case where the updated cleaning map is abnormal indicates that the cleaning device may beat an incorrect position. In this case, the map selection instruction is generated and sent. The user may determine an accurate map for the cleaning device based on the map selection instruction. Such an arrangement enables interactions between the cleaning device and the user; enables the cleaning device to store the map based on user demands; and can also ensure the accuracy of a next operation of the cleaning device even if the cleaning device is in the incorrect position, thereby ensuring the cleaning efficiency, reducing the idle running probability of the cleaning device, preventing a situation that the cleaning device, due to indecision in map selection, would require the user to move it manually, eliminating the need for the cleaning device to engage in repetitive map construction or for the user to frequently delete maps, and reducing the operation difficulty of the user and improving the user experience.

In step 104, a user selection instruction is received, and a map stored in the cleaning device is updated based on the user selection instruction. It may be understood that the user's response to the map selection instruction indicates that the user has recognized that the cleaning device is at an incorrect position on the map. In this case, the user makes a response to the map selection instruction and may send the user selection instruction. This indicates that the user has confirmed which map the cleaning device should store for its next operation. Therefore, the cleaning device may update the map based on a user’s selection result, meeting user’s cleaning expectations and further improving the user experience.

Through the control method provided by the embodiments of the present disclosure, the cleaning device collects the map construction data for constructing the updated cleaning map while executing the operation, and then constructs the updated cleaning map based on the map construction data. For a non-brand-new device, before executing the operation, the cleaning device stores the original cleaning map; and in a case where the updated cleaning map is abnormal, for example, in a case where the cleaning device is at an incorrect position on the map, the map selection instruction may be sent, and the user may select, based on the map selection instruction, the updated cleaning map or the original cleaning map to instruct the cleaning device to update the map stored in the cleaning device, such that even if the cleaning device is in the incorrect position, the cleaning device can always store an accurate map. This ensures the cleaning efficiency, reduces the idle running probability of the cleaning device, prevents a situation that the cleaning device, due to indecision in map selection, would require the user to move it manually, eliminates the need for the cleaning device to engage in repetitive map construction or for the user to frequently delete maps, and reduces the operation difficulty of the user and thus improves the user experience.

In an embodiment, the step that in response to the cleaning instruction, during the operation of the cleaning device, the map construction data for constructing the updated cleaning map is acquired includes: in response to the cleaning instruction, in the presence of an original cleaning map, the map construction data for constructing the updated cleaning map is acquired during the operation of the cleaning device; and in the absence of the original cleaning map, the cleaning device is controlled to perform a cleaning operation and the original cleaning map is acquired.

In this technical solution, considering that in a case where the cleaning device is a brand-new device or the cleaning device is operating in a new operating area, no original cleaning map may exist in the cleaning device. In this case, the cleaning device may be controlled to perform an operation, construct a map, and store this map as the original cleaning map. Such an arrangement facilitates the next operation of the cleaning device and can improve the operating efficiency.

In some examples, after the original cleaning map is acquired for the first time, the original cleaning map may also be sent to a terminal, such that the terminal may store and display the original cleaning map.

In an embodiment, the step that the map construction data for constructing the updated cleaning map is acquired during the operation of the cleaning device includes: at least one of laser data, odometry data and gyroscope data is acquired during the movement of the cleaning device. With such an arrangement, the updated cleaning map can be constructed based on at least one of the laser data, the odometer data, and the gyroscope data, and the updated cleaning map is constructed based on data of the previous operation of the cleaning device, making the updated cleaning map more accurate. It may be understood that in a case where the cleaning device is a brand-new device or the cleaning device is operating in a new operating area, the cleaning device may construct the original cleaning map based on at least one of the laser data, the odometer data and the gyroscope data.

In an embodiment, the step that the updated cleaning map is acquired based on the map construction data includes: in a case where the cleaning device is in a stationary state, the updated cleaning map is acquired based on the map construction data.

In this technical solution, an opportunity is further provided for acquiring and constructing the updated cleaning map, and in a case where the cleaning device is in a stationary state, that is, in a case where the cleaning device is not performing the cleaning operation, the map is constructed. On the one hand, a backup original map is not corrected during the movement of the cleaning device to effectively ensure a navigation effect, and correct map information can be retained for recovery in case of map abnormality due to tracking failure. On the other hand, map information is corrected in a case where the cleaning device is in the stationary state, which does not consume processor's computing resources during the movement of the cleaning device, thereby being able to improve the correction efficiency of the map information and reduce the processor cost. Furthermore, map information can be corrected offline without user intervention, thereby providing greater autonomy and enhanced user experience.

In an embodiment, the step that, in a case where the updated cleaning map is abnormal, the map selection instruction is generated includes: in a case where the updated cleaning map is abnormal and an interactive state of the cleaning device is enabled, the map selection instruction is generated; and in a case where the updated cleaning map is abnormal and the interactive state of the cleaning device is disenabled, prompt information is sent to a terminal, an original cleaning map is sent to the terminal, and the map stored in the cleaning device is updated based on the original cleaning map.

In this technical solution, in a case where the updated cleaning map is abnormal, whether the cleaning device is in the interactive state may be further determined. The case where the interactive state of the cleaning device is enabled indicates that the user may interact with the cleaning device, and in this case, the map selection instruction may be generated. Conversely, the case where the interactive state of the cleaning device is disenabled indicates that the user cannot or does not want to interact with the cleaning device, and in this case, no map selection instruction is generated. Instead, prompt information is generated to prompt the user about the map abnormality, and the map stored in the cleaning device is updated based on the original cleaning map. Furthermore, the original cleaning map is sent to the terminal for the user to view. Such an arrangement better meets user demands. In a case where the user does not wish to interact with the cleaning device, the cleaning device can send prompt and display information, thereby improving the user experience. Furthermore, the cleaning device can perform its next operation based on the original cleaning map, thereby ensuring the smooth progress of the cleaning operation.

In an embodiment, the step that based on a response result of the map selection instruction, the user selection instruction is received and based on the user selection instruction, the map stored in the cleaning device is updated includes: the user selection instruction is received, the map corresponding to the user selection instruction is used as a new original cleaning map of the cleaning device, and the map corresponding to the user selection instruction is sent to the terminal.

In this technical solution, a method is further provided for updating the map of the cleaning device. The user can make a choice between the original cleaning map and the updated cleaning map, and then generate the user selection instruction based on the selection result. In a case where the user selects the original cleaning map, the map stored in the cleaning device is updated based on the original cleaning map, and then the original cleaning map is fed back to the terminal. In a case where the user selects the updated cleaning map, the map stored in the cleaning device is updated based on the updated cleaning map, and then the cleaning map is fed back to the terminal.

In an embodiment, the control method for the cleaning device further includes: in a case where the updated cleaning map is accurate, the map stored in the cleaning device is updated based on the updated cleaning map, and the updated cleaning map is sent to the terminal.

In this technical solution, in a case where the updated cleaning map is accurate, the updated cleaning map is used as a new original cleaning map to update the map stored in the cleaning device, so that the map stored in the cleaning device can be optimized and thus more accurate.

In an embodiment, the control method for the cleaning device further includes: a matching degree between the updated cleaning map and the original cleaning map is acquired; and in a case where the matching degree is lower than a preset value, the updated cleaning map is determined to be abnormal.

In this technical solution, the step of determining whether the updated cleaning map is abnormal is further provided. After the updated cleaning map is acquired, the original cleaning map may be compared with the updated cleaning map. If the matching degree between the updated cleaning map and the original cleaning map is lower than the preset value, the updated cleaning map may be identified as being abnormal. On the contrary, if the matching degree between the updated cleaning map and the original cleaning map is higher than or equal to the preset value, it indicates that the updated cleaning map is normal. It may be understood that the preset value may be set by the user or set by default in the processor. A larger preset value results in more outdated map details, while a smaller preset value increases the map update frequency. This occurs because the larger preset value makes it less likely to satisfy this condition, leading to the map being more easily deemed erroneous. When this happens, the original cleaning map replaces the updated cleaning map, resulting in more outdated map details. Conversely, the smaller preset value increases the update frequency, thereby enhancing the real-time accuracy of the map.

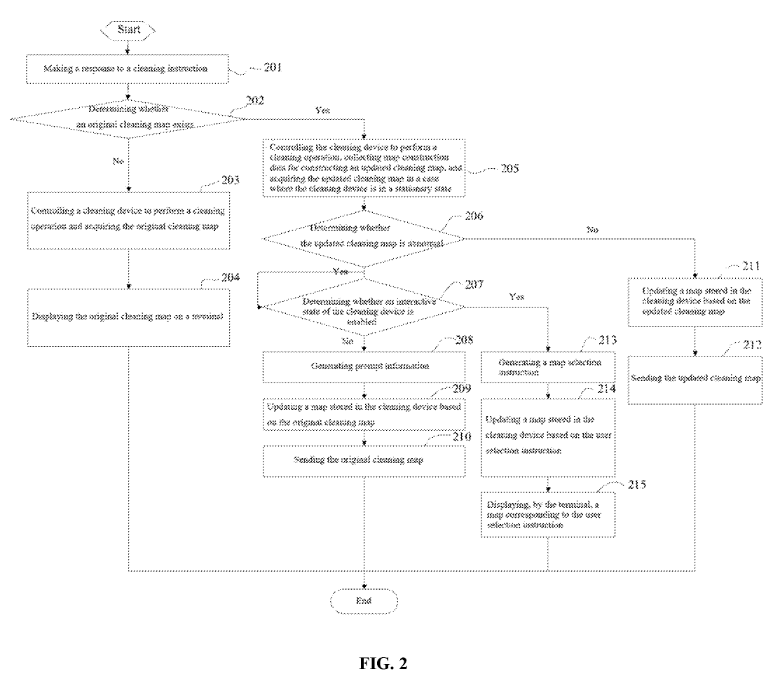

As shown in FIG. 2, the control method for the cleaning device may include:

step 201: making a response to a cleaning instruction;

step 202: determining whether an original cleaning map exists; if yes, executing step 205; and if not, executing step 203;

step 203: controlling the cleaning device to perform a cleaning operation and acquiring the original cleaning map;

step 204: displaying the original cleaning map on a terminal;

step 205: controlling the cleaning device to perform a cleaning operation, collecting map construction data for constructing an updated cleaning map, and acquiring the updated cleaning map in a case where the cleaning device is in a stationary state;

step 206: determining whether the updated cleaning map is abnormal; if yes, executing step 207; and if not, executing step 211;

step 207: determining whether an interactive state of the cleaning device is enabled; if yes, executing step 213; and if not, executing step 208;

step 208: generating prompt information;

step 209: updating a map stored in the cleaning device based on the original cleaning map;

step 210: sending the original cleaning map;

step 211: updating, based on the updated cleaning map, the map stored in the cleaning device;

step 212: sending the updated cleaning map;

step 213: generating a map selection instruction;

step 214: updating, based on the user selection instruction, the map stored in the cleaning device; and

step 215: displaying, by the terminal, a map corresponding to the user selection instruction.

Through the control method provided by the embodiments of the present disclosure, the cleaning device will construct the updated cleaning map while executing the operation. For a non-brand-new device, before performing the operation, the cleaning device stores the original cleaning map. It may be found that in a case where the updated cleaning map is abnormal, the user can choose, based on the map selection instruction, the updated cleaning map or the original cleaning map to instruct the cleaning device to perform the operation and update the map, such that the cleaning device can always store a map that adapts to user expectations, thereby reducing the operation difficulty of the user and improving the user experience. In addition, interactive guidance can be achieved for the user to select a normal map without the need for the user to manually delete maps and reconstruct the maps. Furthermore, with user authorization, the map can be updated without user intervention.

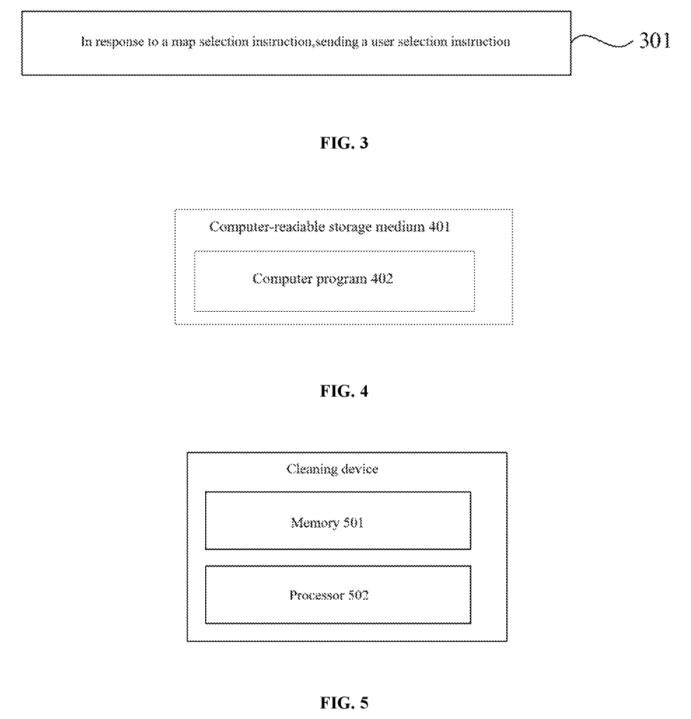

As shown in FIG. 3, according to a second aspect of embodiments of the present disclosure, a control method for a cleaning device is proposed. The control method is applicable to a terminal and includes:

step 301: in response to a map selection instruction, sending a user selection instruction, wherein the user selection instruction includes an original cleaning map selection instruction or an updated cleaning map selection instruction.

Through the control method provided by the embodiments of the present disclosure, a terminal may be in communication connection with the cleaning device; and after the terminal receives the map selection instruction, the user can make a response to the map selection instruction and control the device to update the map based on the updated cleaning map or the original cleaning map. Based on this, the cleaning device can always store a map that adapts to user demands, which ensures the cleaning efficiency, reduces the idle running probability of the cleaning device, prevents a situation that the cleaning device, due to indecision in map selection, would require the user to move it manually, eliminates the need for the cleaning device to engage in repetitive map construction or for the user to frequently delete maps, and reduces the operation difficulty of the user and thus improves the user experience.

In an embodiment, the control method for the cleaning device further includes: receiving and displaying the original cleaning map; and/or receiving and displaying the updated cleaning map.

It may be understood that after the terminal in communication connection to the cleaning device receives the original cleaning map and/or the updated cleaning map, it may display the original cleaning map and/or the updated cleaning map. This, on the one hand, clearly defines the operation state of the cleaning device, and on the other hand, allows the user to visually inspect the original cleaning map and/or the updated cleaning map, which is convenient for the user to discover map errors punctually, and facilitates timely correction to both the operation mode and the map of the cleaning device.

As shown in FIG. 4, according to a third aspect of embodiments of the present disclosure, a non-transitory computer-readable storage medium 401 is proposed. The non-transitory computer-readable storage medium 401 stores a computer program 402 to implement the control method of any of the above technical solutions.

The non-transitory computer-readable storage medium 401 provided by the embodiments of the present disclosure implements the control method of any of the above technical solutions and thus has all the beneficial effects of the control method of any of the above technical solutions.

Through the non-transitory computer-readable storage medium 401 provided by the embodiments of the present disclosure, the cleaning device constructs the updated cleaning map while executing the operation. For a non-brand-new device, the cleaning device collects the map construction data for constructing the updated cleaning map while executing the operation and then constructs the updated cleaning map based on the map construction data. For a non-brand-new device, before executing the operation, the cleaning device stores the original cleaning map; and in a case where the updated cleaning map is abnormal, for example, in a case where the cleaning device is at an incorrect position on the map, the map selection instruction may be sent, and the user may select, based on the map selection instruction, the updated cleaning map or the original cleaning map to instruct the cleaning device to perform the operation, such that even if the cleaning device is in the incorrect position, the cleaning device can also continue operating. This ensures the cleaning efficiency, reduces the idle running probability of the cleaning device, prevents a situation that the cleaning device, due to indecision in map selection, would require the user to move it manually, eliminates the need for the cleaning device to engage in repetitive map construction or for the user to frequently delete maps, and reduces the operation difficulty of the user and thus improves the user experience.

Based on this understanding, the technical solution of the present disclosure may be embodied in the form of a software product. The software product may be stored in a non-volatile storage medium (which may be a CD-ROM, a USB flash drive, a mobile hard disk, etc.) and includes a number of instructions to cause a computer device (which may be a personal computer, a server, or a network device, etc.) to execute the method of each implementation scenario of the present disclosure.

As shown in FIG. 5, according to a fourth aspect of embodiments of the present disclosure, an electronic device is proposed. The electronic device includes: a memory 501 configured to store a computer program; and a processor 502 configured to execute the computer program. The processor 502, when executing the computer program, implements the control method of any of the above technical solutions.

Through the electronic device provided by the embodiments of the present disclosure, the cleaning device constructs the updated cleaning map while executing the operation. For a non-brand-new device, the cleaning device collects the map construction data for constructing the updated cleaning map while executing the operation and then constructs the updated cleaning map based on the map construction data. For a non-brand-new device, before executing the operation, the cleaning device stores the original cleaning map; and in a case where the updated cleaning map is abnormal, for example, in a case where the cleaning device is at an incorrect position on the map, the map selection instruction may be sent, and the user may select, based on the map selection instruction, the updated cleaning map or the original cleaning map to instruct the cleaning device to perform the operation, such that even if the cleaning device is in the incorrect position, the cleaning device can also continue operating. This ensures the cleaning efficiency, reduces the idle running probability of the cleaning device, prevents a situation that the cleaning device, due to indecision in map selection, would require the user to move it manually, eliminates the need for the cleaning device to engage in repetitive map construction or for the user to frequently delete maps, and reduces the operation difficulty of the user and thus improves the user experience.

The electronic device provided by the embodiments of the present disclosure implements the control method of any of the above technical solutions, and thus has all the beneficial effects of the control method of any of the above technical solutions.

In some examples, the electronic device may also include a user interface, a network interface, a camera, a radio frequency (RF) circuit, a sensor, an audio circuit, a WI-FI module, etc. The user interface may include a display screen, an input unit such as a keyboard, etc. Optionally, the user interface may also include a USB interface, a card reader interface, etc. Optionally, the network interface may include a standard wired interface, a standard wireless interface (such as a WI-FI interface), etc.

In an exemplary embodiment, the electronic device may also include an input/output interface and a display device. Various functional units may communicate with each other through a bus. The memory stores a computer program, and the processor is configured to execute the program stored in the memory to execute the method in the above embodiment.

The above storage medium may further include an operating system and a network communication module. The operating system is a program that manages hardware and software resources of an entity device of the above method and supports the running of information processing programs and other software and/or programs. The network communication module is configured to achieve communication between components within the storage medium, as well as communication with other hardware and software in an information processing entity device.

Through the above description of the embodiments, those skilled in the art can clearly understand that the present disclosure can be implemented by means of software and a necessary general hardware platform, or can also be implemented by hardware.

The present disclosure is described with reference to the flowcharts and/or block diagrams of methods, devices (systems), and computer program products according to the embodiments of the present disclosure. It should be understood that each process and/or block in the flowcharts and/or block diagrams, and combinations of processes and/or blocks in the flowcharts and/or block diagrams, may be implemented by the computer program instructions. These computer program instructions may be provided to a processor of a general-purpose computer, a special-purpose computer, an embedded computer, or other programmable data processing device to produce a machine, such that the instructions executed by the processor of the computer or other programmable data processing device produce means for implementing the functions specified in a process or processes in a flowchart and/or a block or blocks in a block diagram.

According to a fifth aspect of embodiments of the present disclosure, a cleaning device is proposed. The cleaning device includes the electronic device of the above technical solution; a cleaning device and a base station. The electronic device is in communication connection with the cleaning device and/or the base station.

The cleaning device provided by the embodiments of the present disclosure includes the electronic device of the above technical solution and thus has all the beneficial effects of the electronic device of the above technical solution, which will not be repeated here.

It may be understood that the terminal is in communication connection with the cleaning device. Based on this, interactive guidance can be achieved for the user to select a normal map without the need for the user to manually delete maps and reconstruct the maps. Furthermore, with user authorization, the map can be updated without user intervention.

In a first aspect of the present disclosure, a control method for a cleaning device is provided.

In a second aspect of the present disclosure, a non-transitory computer-readable storage medium is provided.

In a third aspect of the present disclosure, a cleaning device is provided.

In a fourth aspect of the present disclosure, a cleaning system is provided.

In view of this, according to a first aspect of embodiments of the present disclosure, a control method for a cleaning device is proposed. The control method for the cleaning device includes:

in response to a cleaning instruction, during operation of the cleaning device, acquiring map construction data for constructing an updated cleaning map;

acquiring the updated cleaning map based on the map construction data;

in a case where the updated cleaning map is abnormal, generating a map selection instruction; and

receiving a user selection instruction and based on the user selection instruction, updating a map stored in the cleaning device.

In an embodiment, the step of in response to the cleaning instruction, during the operation of the cleaning device, acquiring the map construction data for constructing the updated cleaning map includes:

in response to the cleaning instruction, in the presence of an original cleaning map, during the operation of the cleaning device, acquiring the map construction data for constructing the updated cleaning map; and

in the absence of the original cleaning map, controlling the cleaning device to perform a cleaning operation and acquiring the original cleaning map.

In an embodiment, the step of, during the operation of the cleaning device, acquiring the map construction data for constructing the updated cleaning map includes:

during the movement of the cleaning device, acquiring at least one of laser data, odometer data and gyroscope data.

In an embodiment, the step of acquiring the updated cleaning map based on the map construction data includes:

in a case where the cleaning device is in a stationary state, acquiring the updated cleaning map based on the map construction data.

In an embodiment, the step of, in a case where the updated cleaning map is abnormal, generating the map selection instruction includes:

in a case where the updated cleaning map is abnormal and an interactive state of the cleaning device is enabled, generating the map selection instruction; and

in a case where the updated cleaning map is abnormal and the interactive state of the cleaning device is disenabled, sending prompt information to a terminal, sending an original cleaning map to the terminal, and updating the map stored in the cleaning device based on the original cleaning map.

In an embodiment, the step of receiving the user selection instruction and based on the user selection instruction, updating the map stored in the cleaning device includes:

receiving the user selection instruction, using a map corresponding to the user selection instruction as a new original cleaning map of the cleaning device, and sending the map corresponding to the user selection instruction to a terminal.

In an embodiment, the control method for the cleaning device further includes:

in a case where the updated cleaning map is accurate, updating the map stored in the cleaning device based on the updated cleaning map, and sending the updated cleaning map to the terminal.

In an embodiment, the control method further includes:

acquiring a matching degree between the updated cleaning map and the original cleaning map; and

in a case where the matching degree is lower than a preset value, determining that the updated cleaning map is abnormal.

In an embodiment, the preset value is set by a user or set by default in a processor of a terminal.

According to a second aspect of embodiments of the present disclosure, a control method for a cleaning device is proposed, which is applicable to a terminal and includes:

in response to a map selection instruction, sending a user selection instruction, wherein

the user selection instruction includes an original cleaning map selection instruction or an updated cleaning map selection instruction.

In an embodiment, the control method for the cleaning device further includes:

receiving and displaying an original cleaning map; and/or

receiving and displaying an updated cleaning map.

According to a third aspect of embodiments of the present disclosure, a non-transitory computer-readable storage medium is provided.

The non-transitory computer-readable storage medium stores a computer program to implement the control method as described in any of the above technical solutions.

According to a fourth aspect of embodiments of the present disclosure, a cleaning device is provided. The cleaning device includes:

a memory, configured to store a computer program; and

a processor, configured to execute the computer program, wherein

the processor, when executing the computer program, implements the control method as described in any of the above technical solutions.

According to a fifth aspect of embodiments of the present disclosure, a cleaning system is proposed. The cleaning system includes:

the cleaning device as described in the above technical solution; and

a cleaning base station, configured to provide maintenance for the cleaning device.

Compared with the prior art, the present disclosure at least includes the following beneficial effects.

Through the control method provided by the embodiments of the present disclosure, when the control method is applied to the cleaning device side, the cleaning device collects the map construction data for constructing the updated cleaning map while executing the operation, and then constructs the updated cleaning map based on the map construction data. For a non-brand-new device, before executing the operation, the cleaning device stores the original cleaning map; and in a case where the updated cleaning map is abnormal, for example, in a case where the cleaning device is at an incorrect position on the map, the map selection instruction may be sent, and the user may select, based on the map selection instruction, the updated cleaning map or the original cleaning map to instruct the cleaning device to update the map stored in the cleaning device, such that even if the cleaning device is in an incorrect position, the cleaning device can always store an accurate map. This ensures the cleaning efficiency, reduces the idle running probability of the cleaning device, prevents a situation that the cleaning device, due to indecision in map selection, would require the user to move it manually, eliminates the need for the cleaning device to engage in repetitive map construction or for the user to frequently delete maps, and reduces the operation difficulty of the user and thus improves the user experience.

In the present disclosure, the terms "first", "second" and "third" are only for the purpose of description and should not be construed as indicating or implying relative importance. The term "a plurality of" means two or more, unless otherwise expressly defined. The terms "install", "connected with", "connected to", "fixed" and the like should be understood broadly. For example, the term "connection" may refer to a fixed connection, a detachable connection or an integrated connection; and the term "connected with" may refer to directly connected or indirectly connected via an intermediate medium. For those of ordinary skill in the art, specific meanings of the foregoing above terms in the present disclosure may be understood based on specific situations.

In the description of the present disclosure, it should be understood that the orientation or positional relationships indicated by the terms such as "upper", "lower", "left", "right", "front" and "rear" are orientation or positional relationships shown based on the drawings, and are merely for the purposes of describing the present disclosure and simplifying the description, rather than indicating or implying that the apparatus or unit referred to must have a specific direction, or must be configured and operated in a specific orientation, Therefore, these terms should not be understood as limitations to the present disclosure.

In the description, the description of the terms "an embodiment", "some embodiments", "specific embodiments" and the like means that specific features, structures, materials or characteristics described in conjunction with the embodiment(s) or example(s) are included in at least one embodiment or example of the present disclosure. In the present description, the illustrative expressions of the above terms do not necessarily refer to the same embodiments or examples. Moreover, the specific features, structures, materials or characteristics described may be combined in any one or more embodiments or examples in any suitable manner.

Described above are only preferred embodiments of the present disclosure, but are not intended to limit the present disclosure. Various changes and modifications may be made to the present disclosure for those skilled in the art. Any modifications, equivalent substitutions, improvements, etc. made within the spirit and principles of the present disclosure are included within the protection scope of the present disclosure.

What is claimed is:

1. A control method for a cleaning device, executed by the cleaning device and comprising:
in response to a cleaning instruction, during operation of the cleaning device, acquiring map construction data for constructing an updated cleaning map;
based on the map construction data, acquiring the updated cleaning map;
in a case where the updated cleaning map is abnormal, generating a map selection instruction; and
receiving a user selection instruction and based on the user selection instruction, updating a map stored in the cleaning device.

2. The control method for the cleaning device according to claim 1, wherein the step of, in response to the cleaning instruction, during the operation of the cleaning device, acquiring the map construction data for constructing the updated cleaning map comprises:
in response to the cleaning instruction, in the presence of an original cleaning map, during the operation of the cleaning device, acquiring the map construction data for constructing the updated cleaning map; and
in the absence of the original cleaning map, controlling the cleaning device to perform a cleaning operation and acquiring the original cleaning map.

3. The control method for the cleaning device according to claim 1, wherein the step of acquiring the map construction data for constructing the updated cleaning map during the operation of the cleaning device comprises:
during movement of the cleaning device, acquiring at least one of laser data, odometer data or gyroscope data.

4. The control method for the cleaning device according to claim 1, wherein the step of, based on the map construction data, acquiring the updated cleaning map comprises:
in a case where the cleaning device is in a stationary state, acquiring the updated cleaning map based on the map construction data.

5. The control method for the cleaning device according to claim 1, wherein the step of, in a case where the updated cleaning map is abnormal, generating the map selection instruction comprises:
in a case where the updated cleaning map is abnormal and an interactive state of the cleaning device is enabled, generating the map selection instruction; and
in a case where the updated cleaning map is abnormal and the interactive state of the cleaning device is disenabled, sending prompt information to a terminal, sending an original cleaning map to the terminal, and updating the map stored in the cleaning device based on the original cleaning map.

6. The control method for the cleaning device according to claim 1, wherein the step of receiving the user selection instruction and based on the user selection instruction, updating the map stored in the cleaning device comprises:
receiving the user selection instruction, using a map corresponding to the user selection instruction as a new original cleaning map of the cleaning device, and sending the map corresponding to the user selection instruction to the terminal.

7. The control method for the cleaning device according to claim 1, further comprising:
in a case where the updated cleaning map is accurate, updating the map stored in the cleaning device based on the updated cleaning map, and sending the updated cleaning map to the terminal.

8. The control method for the cleaning device according to claim 1, further comprising:
acquiring a matching degree between the updated cleaning map and the original cleaning map; and
in a case where the matching degree is lower than a preset value, determining that the updated cleaning map is abnormal.

9. A control method for a cleaning device, applicable to a terminal and comprising:
in response to a map selection instruction, sending a user selection instruction, wherein
the user selection instruction comprises at least one of an original cleaning map selection instruction or an updated cleaning map selection instruction.

10. The control method for the cleaning device according to claim 9, further comprising at least one of:
receiving and displaying an original cleaning map; or
receiving and displaying an updated cleaning map.

11. A cleaning device, comprising:
a memory configured to store a computer program; and
a processor configured to execute the computer program, wherein
the processor, when executing the computer program, implements following operations:
in response to a cleaning instruction, during operation of the cleaning device, acquiring map construction data for constructing an updated cleaning map;
based on the map construction data, acquiring the updated cleaning map;
in a case where the updated cleaning map is abnormal, generating a map selection instruction; and
receiving a user selection instruction and based on the user selection instruction, updating a map stored in the cleaning device.

12. The cleaning device according to claim 11, wherein the step of, in response to the cleaning instruction, during the operation of the cleaning device, acquiring the map construction data for constructing the updated cleaning map comprises:
in response to the cleaning instruction, in the presence of an original cleaning map, during the operation of the cleaning device, acquiring the map construction data for constructing the updated cleaning map; and
in the absence of the original cleaning map, controlling the cleaning device to perform a cleaning operation and acquiring the original cleaning map.

13. The cleaning device according to claim 11 wherein the step of acquiring the map construction data for constructing the updated cleaning map during the operation of the cleaning device comprises:
during movement of the cleaning device, acquiring at least one of laser data, odometer data or gyroscope data.

14. The cleaning device according to claim 11, wherein the step of, based on the map construction data, acquiring the updated cleaning map comprises:
in a case where the cleaning device is in a stationary state, acquiring the updated cleaning map based on the map construction data.

15. The cleaning device according to claim 11, wherein the step of, in a case where the updated cleaning map is abnormal, generating the map selection instruction comprises:
in a case where the updated cleaning map is abnormal and an interactive state of the cleaning device is enabled, generating the map selection instruction; and
in a case where the updated cleaning map is abnormal and the interactive state of the cleaning device is disenabled, sending prompt information to a terminal, sending an original cleaning map to the terminal, and updating the map stored in the cleaning device based on the original cleaning map.

16. The cleaning device according to claim 11, wherein the step of receiving the user selection instruction and based on the user selection instruction, updating the map stored in the cleaning device comprises:
receiving the user selection instruction, using a map corresponding to the user selection instruction as a new original cleaning map of the cleaning device, and sending the map corresponding to the user selection instruction to the terminal.

17. The cleaning device according to claim 11, wherein the processor further implements following operations:
in a case where the updated cleaning map is accurate, updating the map stored in the cleaning device based on the updated cleaning map, and sending the updated cleaning map to the terminal.

18. The cleaning device according to claim 11, wherein the processor further implements following operations:
acquiring a matching degree between the updated cleaning map and the original cleaning map; and
in a case where the matching degree is lower than a preset value, determining that the updated cleaning map is abnormal.

19. A cleaning system, comprising:
the cleaning device according to claim 11; and
a cleaning base station, configured to provide maintenance for the cleaning device.

20. A non-transitory computer-readable storage medium, wherein
the computer-readable storage medium stores a computer program to implement the control method for the cleaning device according to claim 1.
